(19) United States
(12) Patent Application Publication
(10) Pub. No.: US 2025/0214406 A1
(43) Pub. Date: Jul. 3, 2025

(54) Truck covering system

(71) Applicant: Hongbo WU, Ningbo (CN)

(72) Inventor: Hongbo WU, Ningbo (CN)

(21) Appl. No.: 18/901,485

(22) Filed: Sep. 30, 2024

(30) Foreign Application Priority Data
Dec. 30, 2023 (CN) 202323665470.3
Dec. 30, 2023 (CN) 202323670946.2

(51) Int. Cl. B60J 7/12

(52) U.S. Cl. CPC B60J 7/12

(57) ABSTRACT

A truck covering system includes a car frame mechanism, which is configured to be installed on the side wall of a truck car body, and the truck car body has an open space; a covering mechanism, which is assembled on the car frame mechanism; the car frame mechanism includes: a first transverse frame; a second transverse frame; a longitudinal frame; a first corner mechanism, the front end of the longitudinal frame is fixed to the first transverse frame through the first corner mechanism; a fourth corner mechanism, the rear end of the longitudinal frame is movably connected to the second transverse frame through the fourth corner mechanism; a corner locking mechanism, which is configured in the fourth corner mechanism.

### CROSS-REFERENCE TO RELATED APPLICATIONS

This application claims priority under 35 U.S.C. § 119(a) to Chinese Patent Application No. 2023236654703, filed on Dec. 30, 2023, and Chinese Patent Application No. 2023236709462, filed on Dec. 30, 2023, which is hereby incorporated by reference herein in its entirety.

### TECHNICAL FIELD

The present invention relates generally to a truck covering system for implementing a trunk lid system.

### BACKGROUND ART

Traditionally, pickup trucks are widely used vehicles that can transport cargo and passengers. Passengers are usually placed in the truck cab, while cargo can be stored in the truck bed. Truck beds are usually rectangular and open to the environment to facilitate loading and transporting large and/or oddly shaped cargo. However, exposing the truck bed to the environment may leave the truck bed and/or cargo unprotected. For example, the truck bed and/or cargo may be exposed to dust, precipitation (e.g., rain, snow, hail), etc. Therefore, some truck owners purchase truck covers to protect the truck bed and the items stored in the truck.

Existing truck covering system has exposed some defects during use, for example: the lock tongue on the corner piece is set horizontally, and the corner piece is rotated during the unfolding or storage process. During the rotation process, the lock tongue contacts and locks with the longitudinally set frame, and the area of the contact part changes continuously (taking downward pressure as an example, the contact area changes from small to large). The consequences are at least: first, the lock tongue is unevenly stressed and easily deformed and damaged; second, the lock tongue does not move in place, and the user thinks it is locked but it is not actually locked. Then, the vehicle is affected by external factors such as bumps during driving, causing the corner piece (cover) to open relative to the frame. 2. Since the frame of the carriage is made of metal (usually aluminum alloy), the edges of the metal frame are often sharp, and the leather (cloth) cover mechanism covers the metal frame. During the process of unfolding or retracting the leather (cloth) covering mechanism, the leather (cloth) covering mechanism is easily clamped in the gap between the longitudinal frame and the second corner mechanism, at which time it is easy to be squeezed and scratched, thereby causing damage to the leather (cloth) covering mechanism and reducing the shielding effect.

### SUMMARY

In order to overcome the above-mentioned deficiencies in the prior art, the present invention provides a truck covering system.

The technical solution of the present invention to solve the technical problem is: a truck covering system, comprising:
a car frame mechanism configured to be mounted to a side wall of a truck car having an open space;
A cover mechanism, which is mounted on the carriage frame mechanism, and the cover mechanism has at least an unfolded position and a stowed position relative to the carriage frame mechanism;

The carriage frame mechanism includes:

A first transverse frame is disposed on the front edge of the freight car body;
A second transverse frame is disposed on the rear edge of the freight car body;
A longitudinal frame is disposed on the left and right edges of the freight car body, and the longitudinal frame is located between the first transverse frame and the second transverse frame;
A first corner mechanism, wherein the front end of the longitudinal frame is fixed to the first transverse frame via the first corner mechanism;
A fourth corner mechanism, wherein the rear end of the longitudinal frame is movably connected to the second transverse frame via the fourth corner mechanism;
A corner locking mechanism is arranged in the fourth corner mechanism, and the corner locking mechanism has at least an unlocking state and a locking state relative to the fourth corner mechanism;
When the corner locking mechanism is in the unlocked state, the second transverse frame can move and separate relative to the longitudinal frame, so that the cover mechanism can switch between the unfolded position state and the stored position state;
When the corner locking mechanism is in the locked state, the fourth corner mechanism engages the second transverse frame with the longitudinal frame to restrict the cover mechanism from switching between the unfolded position state and the stored position state.

According to some embodiments of the present disclosure, the fourth corner mechanism includes:
A second linear connecting member, having a first longitudinal connecting block at one end and a first longitudinal slot at the other end;
a rear end steering connection member having a first transverse connection block on one side and a first longitudinal positioning end on the other side;
The first longitudinal connection block is inserted into the longitudinal frame, the first transverse connection block is inserted into the second transverse frame, and the first longitudinal positioning end is inserted into the first longitudinal slot, so that the longitudinal frame is connected to the second transverse frame through the fourth corner mechanism.

According to some embodiments of the present disclosure, the corner locking mechanism includes:
A locking groove, arranged on the rear end steering connection member;
A lock buckle is arranged on the second linear connecting member, the upper end of the lock slot is closed and the lower end is provided with an unlocking opening;
retractable latch assembly is disposed on the rear end steering connection member, and the retractable latch assembly can be extended into the lock slot or withdrawn out of the lock slot;
When the retractable latch assembly is withdrawn to the lock slot, the lock catch can be disengaged from the lock slot along the unlocking opening, so that the first longitudinal positioning end can be disengaged from the first longitudinal slot, and the corner locking mechanism is correspondingly in an unlocked state;
When the retractable latch assembly extends into the lock slot, the retractable latch assembly blocks the lower end of the lock buckle and forms a limit stop with the lock buckle, so that the lock buckle cannot escape from the lock slot, so that the first longitudinal positioning end is limited in the first longitudinal slot, and the corner locking mechanism is correspondingly in a locked state.

Furthermore, the lower side and both left and right sides of the first longitudinal slot are formed with ribs, and the upper end of the first longitudinal slot is provided with an insertion opening;
The first longitudinal positioning end extends into or out of the first longitudinal slot through the insertion opening.

Further, including:
A bottom plate is arranged between the first corner mechanism/the fourth corner mechanism and the longitudinal frame;
The bottom plate has a horizontal portion and a vertical portion, wherein the horizontal portion is fixed to the first corner mechanism/the fourth corner mechanism via a first fastening element, and the vertical portion is fixed to the longitudinal frame via a second fastening element.

Furthermore, the lock buckle is sleeved with a first spring, the lock buckle has a lock portion for inserting into a lock slot, the upper end of the lock portion has a pressure end surface, and the lower end of the lock portion has a limit end surface;
When force is applied to the pressure end surface, the lock buckle retracts and disengages from the lock groove; when force is applied to the limit end surface, the lock buckle continues to remain in the lock groove under the action of the first spring.

Furthermore, the lock buckle is arranged in the first longitudinal connection block of the second linear connection member, and the retractable latch assembly is arranged outside the first transverse connection block of the rear end steering connection member.

Further, the retractable latch assembly comprises a limit section, a main body section and an operating section;
The limiting section can be extended into the lock slot or withdrawn out of the lock slot, and when the limiting section is extended into the lock slot, it forms a limiting stop with the lock buckle;
A second spring is sleeved on the main body section, and the second spring acts on the retractable latch assembly so that the retractable latch assembly always has a movement tendency to move toward one side of the lock slot;
The operating section extends out of the rear end steering connection component.

Further, including:
a pull cord, configured on the retractable latch assembly;
The retractable latch assembly is driven to move by operating the pull rope so that the retractable latch assembly is withdrawn out of the lock slot;
latch assembly will re-extend into the lock slot under the action of the second spring.

Furthermore, the second transverse frame has a slide groove, a movable slider is arranged in the slide groove, the pull rope is connected to the slider, and the pull rope is movably connected to the second transverse frame through the slider.

Furthermore, the first longitudinal connecting block is connected to the longitudinal frame via a first fastener, and the first transverse connecting block is connected to the second transverse frame via a second fastener.

According to some embodiments of the present disclosure, the first corner mechanism includes:
A first linear connecting member, one end of which has a second longitudinal connecting block and a second longitudinal slot, and the other end of which is provided with a transverse slot;
A second corner mechanism, wherein one side has a second transverse connecting block, and the other side has a second longitudinal positioning end and a transverse positioning end;
Insert the second longitudinal positioning end into the second longitudinal slot, and insert the transverse positioning end into the transverse slot to engage the first linear connecting member with the second corner mechanism; then insert the second longitudinal connecting block into the longitudinal frame, and insert the second transverse connecting block into the first transverse frame to engage the longitudinal frame with the first transverse frame through the first corner mechanism.

Furthermore, the second longitudinal connecting block is fixedly connected to the longitudinal frame through a third fastener, the second transverse connecting block is fixedly connected to the first transverse frame through a fourth fastener, and the second longitudinal positioning end is fixedly connected to the first linear connecting member through a fifth fastener.

Furthermore, the first straight connecting member has a first side wall, and the first side wall is located between the second corner mechanism and the longitudinal frame.

Furthermore, the first side wall is arranged on a side of the transverse slot close to the longitudinal frame, and one side surface of the first side wall is in contact with an edge of the longitudinal frame, and the other side surface is in contact with a transverse positioning end portion of the second corner mechanism.

Furthermore, a second side wall is provided on a side of the transverse slot away from the longitudinal frame, and the transverse slot is formed between the second side wall and the first side wall.

Furthermore, the second longitudinal connecting block is recessed inwardly to form the second longitudinal slot, and the second longitudinal slot and the transverse slot are arranged perpendicular to each other.

Further, the height of the first side wall is greater than or equal to the height of the longitudinal frame.

Furthermore, the height of the second side wall is lower than the height of the first side wall.

According to some embodiments of the present disclosure, the first corner mechanism includes:
A third corner mechanism, wherein one side has a third transverse connecting block and the other side has a third longitudinal connecting block, the third longitudinal connecting block is inserted into the longitudinal frame, and the third transverse connecting block is inserted into the first transverse frame, so that the longitudinal frame is connected to the first transverse frame through the first corner mechanism;
Bolts and nuts, the third longitudinal connection block, the longitudinal frame and the bottom plate are all provided with fixed connection holes, the bolts are inserted into the fixed connection holes and then threadedly connected with the nuts;
The sixth fastener, the third transverse connecting block is fixedly connected to the first transverse frame through the sixth fastener.

The beneficial effects of the present invention are:
1. By using the first corner mechanism and the fourth corner mechanism, the independent first transverse frame, the second transverse frame and the longitudinal frame are combined to form an integral structure of the carriage frame mechanism, which can play a shielding and protective function for the open space of the truck compartment after cooperating with the covering mechanism.
2. During the downward pressing process of the rear-end steering connector, the contact area between the lock buckle and the lock groove (rear-end steering connector) remains constant, so the force is evenly distributed, the movement stroke is more stable, and the related components are more durable and reliable.
3. Since the movement stroke is stable enough, the lock buckle can be fully extended and fully enter the lock slot to ensure a good locking effect, thereby ensuring that the connecting part (cover mechanism) will not open relative to the car frame mechanism during the use of the vehicle.
Fourth, in the fifth embodiment, a first straight connecting member is added as a transitional component between the second corner mechanism and the first transverse frame. The first straight connecting member can fill the gap between the second corner mechanism and the frame (longitudinal frame or/first transverse frame), thereby eliminating the situation where a leather or other covering mechanism is stuck in the gap and damaged. At the same time, when in use, the covering mechanism contacts the first straight connecting member with better protection performance, so that the first straight connecting member will not cause damage to the covering mechanism, thereby achieving a good protection effect.
5. The first corner mechanism in the sixth embodiment, on the basis of ensuring the connection strength, has its functions more concentrated on the third corner mechanism and has a simpler structure.

### BRIEF DESCRIPTION OF THE DRAWINGS

FIG. 1 is a comparative schematic diagram of a truck cover system in a truck in an extended position and a stowed position.

FIG. 2 is an assembly diagram of the carriage frame mechanism.

FIG. 3 is a schematic diagram of the carriage frame mechanism during the disassembly and assembly process.

FIG. 4 is a schematic diagram of the use of the fourth corner mechanism.

FIG. 5 is a schematic diagram of the rear end steering connection member when it moves relative to the second straight line connection member.

FIG. 6 is a schematic diagram of the partial structure of the angle locking mechanism in a locked state.

FIG. 7 is a schematic diagram of the partial structure of the corner locking mechanism in an unlocked state.

FIG. 8 is an exploded view of the fourth corner mechanism and the retractable latch assembly.

FIG. 9 is an exploded view of the fourth corner mechanism and the retractable latch assembly at another angle.

FIG. 10 is a schematic diagram showing the separation of the fourth corner mechanism and the carriage frame mechanism.

FIG. 11 is a schematic diagram of partial assembly of the fourth corner mechanism and the carriage frame mechanism.

FIG. 12 is a cross-sectional view of the fourth corner mechanism and the corner locking mechanism and a partially enlarged schematic diagram thereof.

FIG. 13 is a schematic diagram of the assembly of the fourth corner mechanism and the carriage frame mechanism.

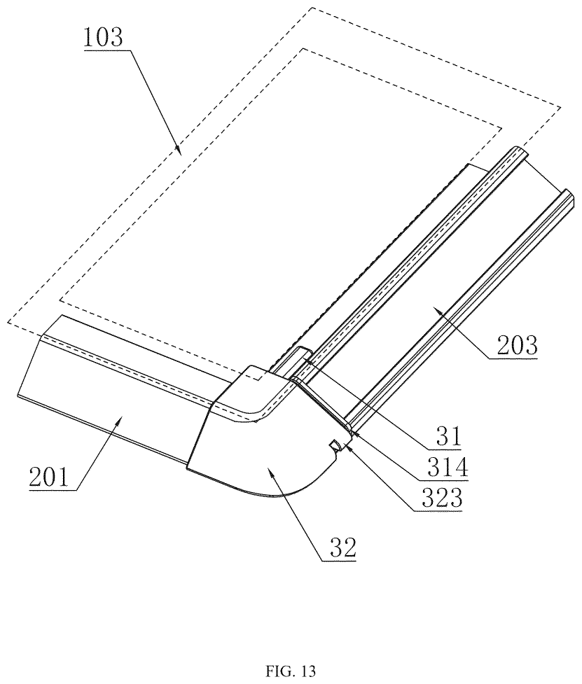

FIG. 14 is an exploded view of the first corner mechanism in the fifth embodiment.

FIG. 15 is a schematic diagram of partial assembly of the first corner mechanism and the carriage frame mechanism in the fifth embodiment.

FIG. 16 is a cross-sectional view and a partially enlarged schematic diagram of the first corner mechanism and the corner locking mechanism in the fifth embodiment.

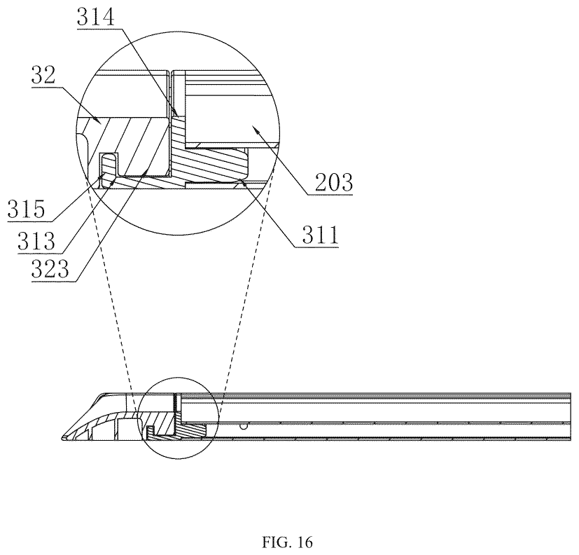

FIG. 17 is a schematic structural diagram of the first straight line connecting member in the fifth embodiment.

FIG. 18 is a schematic structural diagram of the second corner mechanism in the fifth embodiment.

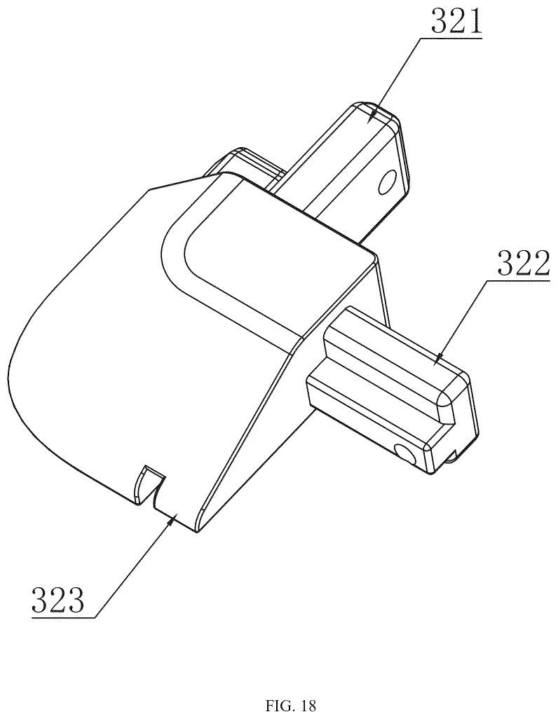

FIG. 19 is a schematic diagram of the disassembly and assembly of the second corner mechanism and the first linear connection member in the fifth embodiment.

FIG. 20 is a schematic diagram of the cooperation between the base plate and the fourth corner mechanism.

FIG. 21 is a schematic diagram of the cooperation between the base plate and the first corner mechanism.

FIG. 22 is an exploded view of the first corner mechanism in the sixth embodiment.

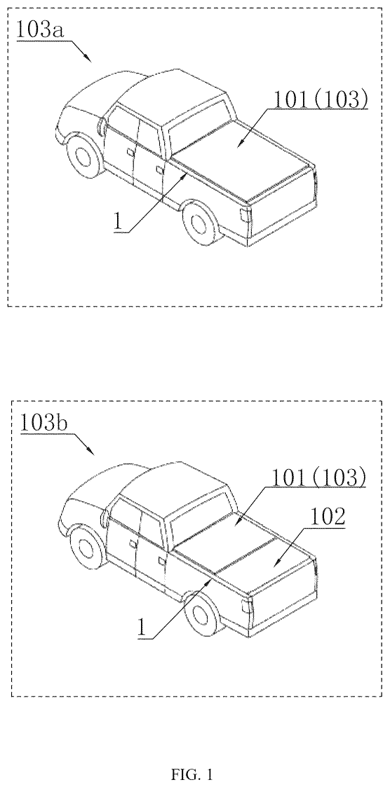

In the FIG. 1, truck compartment; 101, truck covering system; 102, open space; 103, cover mechanism; 103a, unfolded position; 103b, stowed position; 2, compartment frame mechanism; 201, first transverse frame; 202, second transverse frame; 203, longitudinal frame; 3, first corner mechanism; 31, first linear connecting member; 311, second longitudinal connecting block; 3111, third fastener; 312, second longitudinal slot; 313, transverse 3131, through opening; 314, first side wall; 315, second side wall; 32, second corner mechanism; 321, second transverse connecting block; 3211, fourth fastener; 322, second longitudinal positioning end; 3221, fifth fastener; 323, transverse positioning end; 33, third corner mechanism; 331, third transverse connecting block; 3311, sixth fastener; 332, third longitudinal connecting block; 333, bolt; 334, nut; 335, fastener fixed connection hole; 4, fourth corner mechanism; 41, second straight line connection member; 411, first longitudinal connection block; 412, first longitudinal slot; 4121, rib; 4122, insertion port; 413, first fastener; 42, rear end steering connection member; 421, first transverse connection block; 422, first longitudinal positioning end; 4221, arc end face; 423, second fastener; 5, corner locking mechanism; 5a, unlocked state; 5b, locked state; 51, lock slot; 511, closed upper end; 512, unlocking opening; 52, lock buckle; 521, locking head; 5211, pressure end surface; 5212, limiting end surface; 53, first spring; 6, retractable latch assembly; 61, limiting section; 62, main body section; 63, operating section; 64, second spring; 65, pull rope; 651, slide groove; 652, slider; 7, bottom plate; 71, horizontal part; 711, first fastening element; 72, vertical part; 721, second fastening element.

### DETAILED DESCRIPTION

The following will be combined with the drawings in the embodiments of the present invention to clearly and completely describe the technical solutions in the embodiments of the present invention. Obviously, the described embodiments are only part of the embodiments of the present invention, not all of the embodiments. Based on the embodiments of the present invention, all other embodiments obtained by ordinary technicians in this field without creative work are within the scope of protection of the present invention.

### Embodiment 1

1 to 3, a truck covering system 101 includes:
The carriage frame mechanism 2 is configured to be mounted on the side wall of the truck carriage 1, wherein the truck carriage 1 has an open space 102;
A cover mechanism 103, which is assembled on the carriage frame mechanism 2, and the cover mechanism 103 has at least an unfolded position state 103a and a stowed position state 103b relative to the carriage frame mechanism 2;
More specifically, the aforementioned carriage frame mechanism 2 comprises: a first transverse frame 201, which is arranged on the front edge of the freight car 1;
The second transverse frame 202 is arranged on the rear edge of the freight car body 1;
The longitudinal frame 203 is disposed on the left and right edges of the freight car body 1, and the longitudinal frame 203 is located between the first transverse frame 201 and the second transverse frame 202;
It can be understood that the first transverse frame 201, the second transverse frame 202 and the longitudinal frame 203 are combined and connected to form a rectangular frame structure of the base of the carriage frame mechanism 2, which matches the shape of the truck carriage 1. Therefore, after the cover mechanism 103 is assembled on the carriage frame mechanism 2 and the carriage frame mechanism 2 is assembled on the truck carriage 1, the cover mechanism 103 plays a control role on the open space 102 of the truck carriage 1. Specifically, when the cover mechanism 103 is in the unfolded position state 103a, its coverage area is large, so as to shield the open space 102 of the truck carriage 1, play a physical space isolation function, and protect the items in the open space 102; when the cover mechanism 103 is in the storage position state 103b, its coverage area is large, so as to partially or completely expose the open space 102 of the truck carriage 1, so as to facilitate users to take out items from the open space 102 of the truck carriage 1 or put items into the open space 102 of the truck carriage 1.

In actual operation of the truck covering system 101, in order to switch the position state of the cover mechanism 103, at least one end or one side of the carriage frame mechanism 2 needs to be movable relative to the truck carriage 1 after installation. In order to achieve the function of the movable carriage frame mechanism 2, the carriage frame mechanism 2 also includes: a first corner mechanism 3, through which the front end of the longitudinal frame 203 is fixed to the first transverse frame 201; a fourth corner mechanism 4, through which the rear end of the longitudinal frame 203 is movably connected to the second transverse frame 202; a corner locking mechanism 5, which is arranged in the fourth corner mechanism 4, and the corner locking mechanism 5 has at least an unlocking state 5a and a locking state 5b relative to the fourth corner mechanism 4.

It is worth mentioning that the installation positions of the first corner mechanism 3 and the fourth corner mechanism 4 can also be interchanged, and no special limitation is made here.

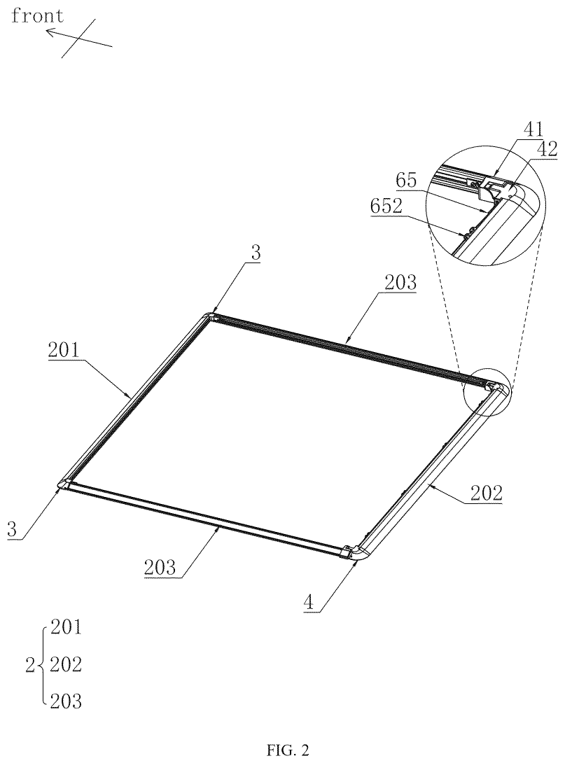

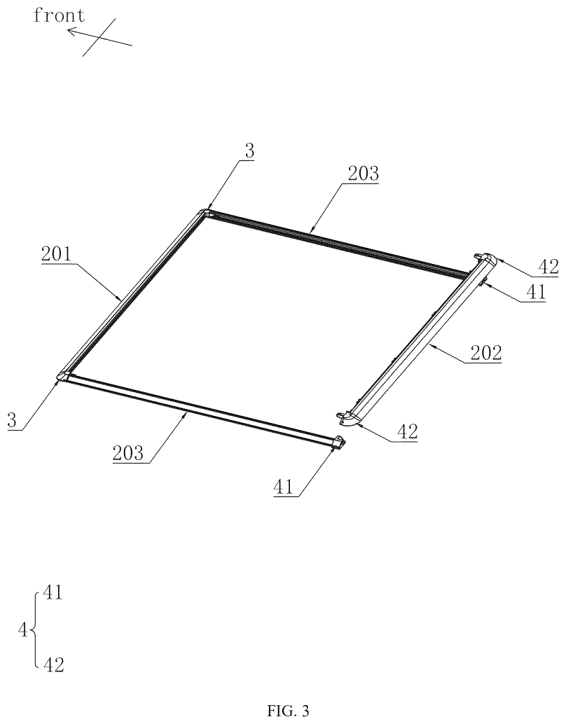

The functional relationship between the corner locking mechanism 5 and the covering mechanism 103 is as follows: referring to FIGS. 2 to 3, when the corner locking mechanism 5 is in the unlocked state 5a, the second transverse frame 202 can move and separate relative to the longitudinal frame 203, so that the covering mechanism 103 can switch between the deployed position state 103a and the stored position state 103b; when the corner locking mechanism 5 is in the locked state 5b, the fourth corner mechanism 4 engages the second transverse frame 202 with the longitudinal frame 203 to limit the covering mechanism 103 from switching between the deployed position state 103a and the stored position state 103b.

In addition, the cover mechanism 103 referred to in the present application is a component that can play a shielding and protective function. The cover mechanism 103 can be a hard cover, such as made of hard plastic; or a soft cover, such as made of soft leather or soft plastic or cloth. The specific material or hardness of the cover mechanism 103 is not specifically limited here.

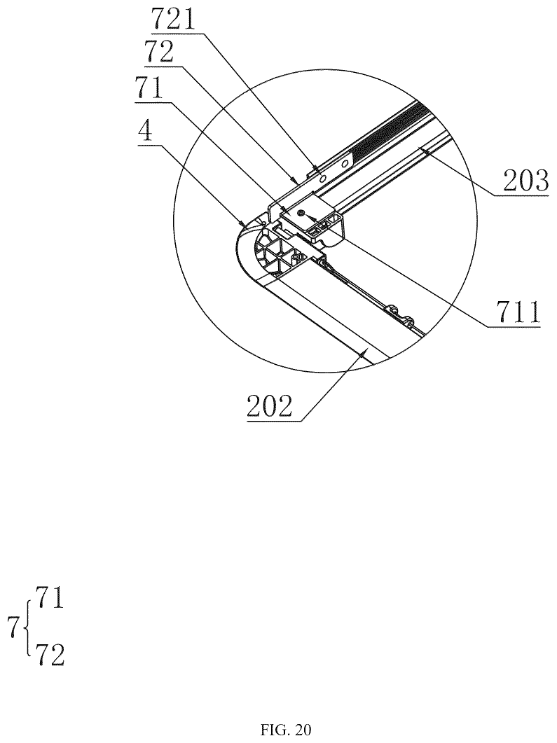

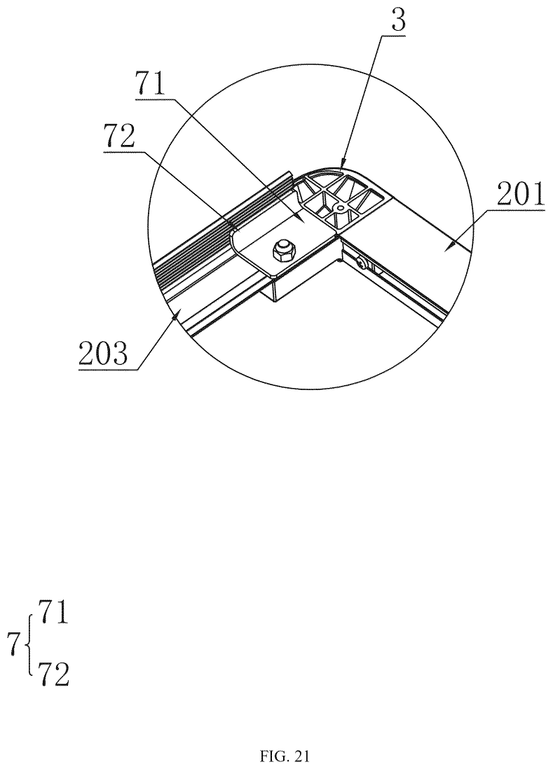

According to some embodiments of the present disclosure, the truck covering system 101 further includes: Referring to FIGS. 20 and 21, a bottom plate 7 is disposed between the first corner mechanism 3/fourth corner mechanism 4 and the longitudinal frame 203; wherein the bottom plate 7 has a horizontal portion 71 and a vertical portion 72, wherein the horizontal portion 71 is fixed to the first corner mechanism 3/fourth corner mechanism 4 by a first fastening element 711, and the vertical portion 72 is fixed to the longitudinal frame 203 by a second fastening element 721. Thus, the bottom plate 7 serves as a structural transition connector, and the first corner mechanism 3/fourth corner mechanism 4 is fixedly connected to the longitudinal frame 203 by the bottom plate 7, so as to provide better support and structural strength, and better cope with the bumps during vehicle driving.

Optionally, the longitudinal frame 203, the first transverse frame 201 and the rear transverse frame are all made of metal to provide sufficient structural strength and supporting function; the first corner mechanism 3 and the fourth corner mechanism 4 are both made of plastic or rubber, which is convenient for production and molding, and is not easy to cause damage to the covering mechanism 103 and the user during operation.

### Embodiment 2

4 to 11, in the truck covering system 101 of the present embodiment, the fourth corner mechanism 4 specifically comprises: a second straight connecting member 41, one end of which has a first longitudinal connecting block 411, and the other end of which is provided with a first longitudinal slot 412; a rear end steering connecting member 42, one side of which has a first transverse connecting block 421, and the other side of which has a first longitudinal positioning end 422. The cooperation principle of the second straight connecting member 41 and the rear end steering connecting member 42 in the present embodiment is: insert the first longitudinal connecting block 411 into the longitudinal frame 203, insert the first transverse connecting block 421 into the second transverse frame 202, and insert the first longitudinal positioning end 422 into the first longitudinal slot 412, so that the longitudinal frame 203 is engaged with the second transverse frame 202 through the fourth corner mechanism 4.

### Embodiment 3

4 to 7, based on the structural scheme of the aforementioned truck covering system 101, the corner locking mechanism 5 includes: a lock slot 51, which is arranged on the rear end steering connecting member 42; a lock buckle 52, which is arranged on the second straight line connecting member 41, and the upper end of the lock slot 51 is closed 511, and the lower end is provided with an unlocking opening 512; a retractable latch assembly 6, which is arranged on the rear end steering connecting member 42, and the retractable latch assembly 6 can be extended into the lock slot 51 or withdrawn to the outside of the lock slot 51.

latch assembly 6 in this embodiment is as follows:

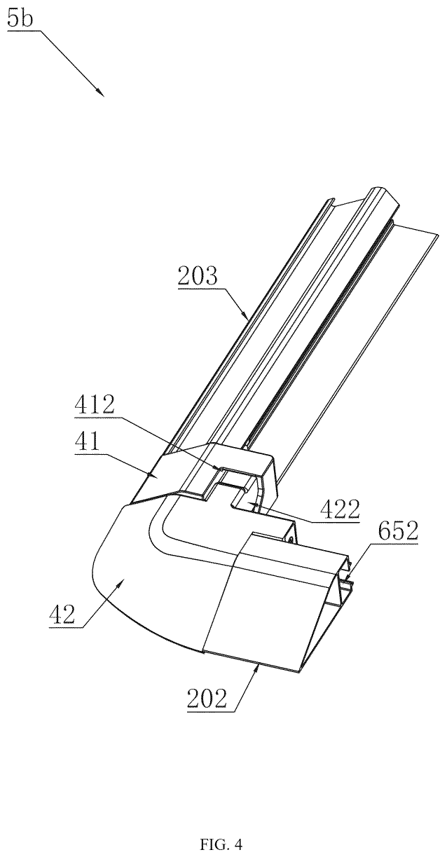

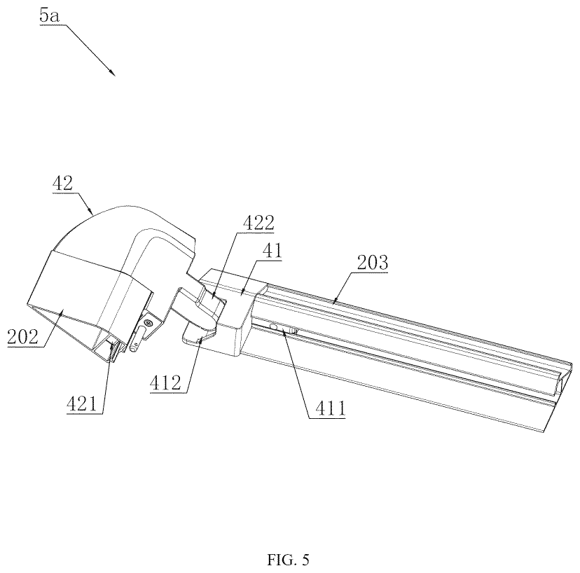

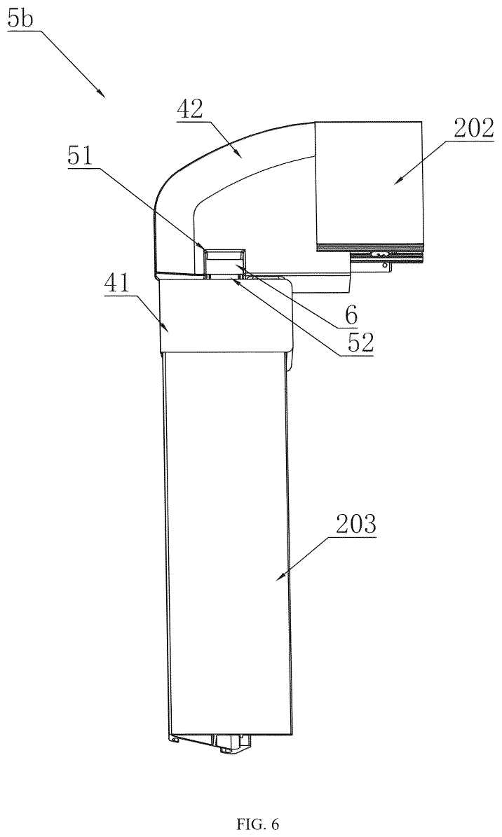

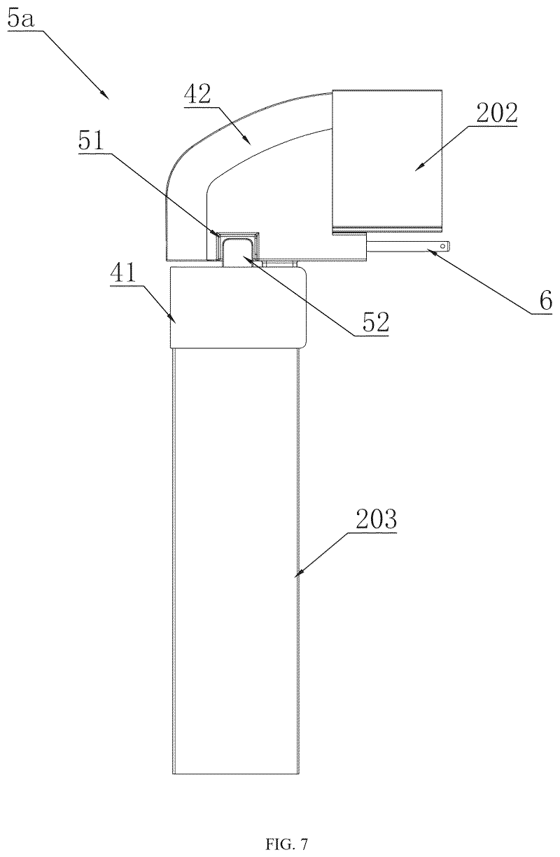

Referring to FIGS. 5 and 7, when the retractable latch assembly 6 is withdrawn to the lock slot 51, the lock buckle 52 can be disengaged from the lock slot 51 along the unlocking opening 512, so that the first longitudinal positioning end 422 can be disengaged from the first longitudinal slot 412, and the corner locking mechanism 5 is correspondingly in the unlocked state 5a; referring to FIGS. 4 and 6, when the retractable latch assembly 6 is extended into the lock slot 51, the retractable latch assembly 6 blocks the lower end of the lock buckle 52 and forms a limit stop with the lock buckle 52, so that the lock buckle 52 cannot be disengaged from the lock slot 51, so that the first longitudinal positioning end 422 is limited in the first longitudinal slot 412, and the corner locking mechanism 5 is correspondingly in the locked state 5b.

Preferably, after the first longitudinal connecting block 411 is inserted into the longitudinal frame 203, the first longitudinal connecting block 411 is connected to the longitudinal frame 203 through the first fastener 413, thereby realizing the fixed connection between the second linear connecting member 41 and the longitudinal frame 203; after the first transverse connecting block 421 is inserted into the second transverse frame 202, the first transverse connecting block 421 is connected to the second transverse frame 202 through the second fastener 423, thereby realizing the fixed connection between the rear end steering connecting member 42 and the second transverse frame 202.

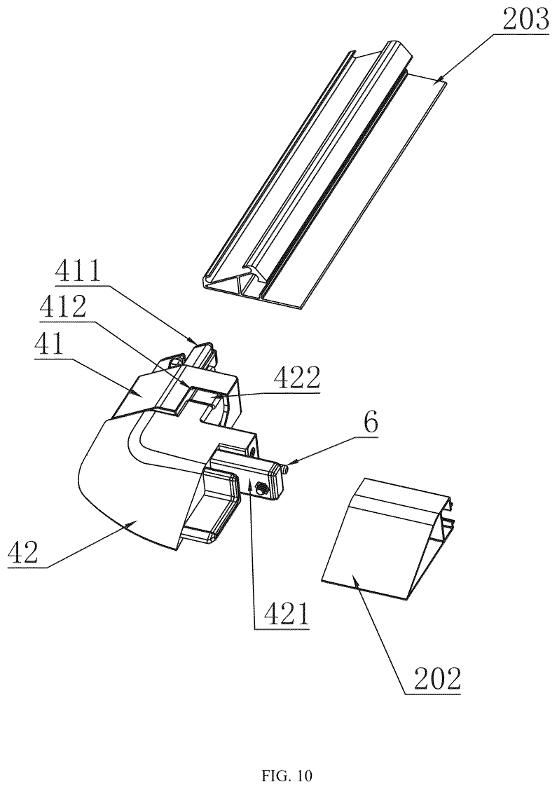

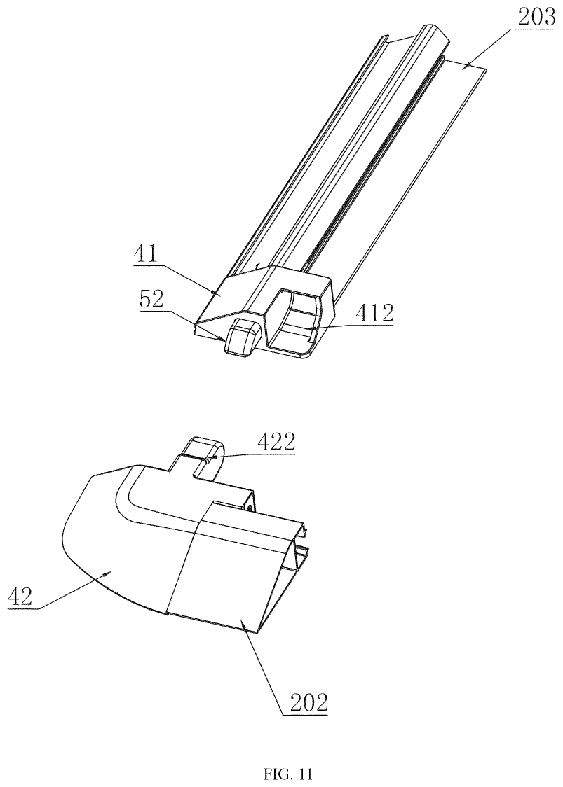

During the unfolding or accommodating process of the capping mechanism 103, the rear end steering connector needs to perform a flipping action relative to the second linear connecting member 41. In order to make the trajectory during flipping more stable, the preferred solution adopted is: with reference to FIGS. 10 and 11, the first longitudinal positioning end 422 has an arc end surface 4221. Furthermore, in order to prevent the second linear connecting member 41 from excessively shaking or flipping toward a non-working direction when rotating, a rib 4121 is formed on the lower side and both left and right sides of the first longitudinal slot 412, and an insertion port 4122 is provided at the upper end of the first longitudinal slot 412, through which the first longitudinal positioning end 422 extends into or leaves the first longitudinal slot 412. When in use, the first longitudinal positioning end 422 is limited in rotation to a certain extent under the action of the rib 4121, and the setting of the insertion port 4122 allows it to only enter and exit along the insertion port 4122, and obtain an effective guiding effect.

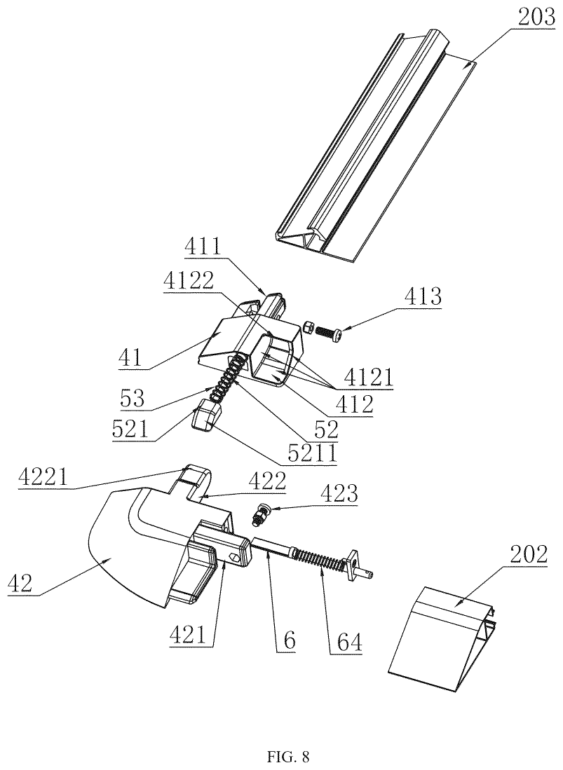

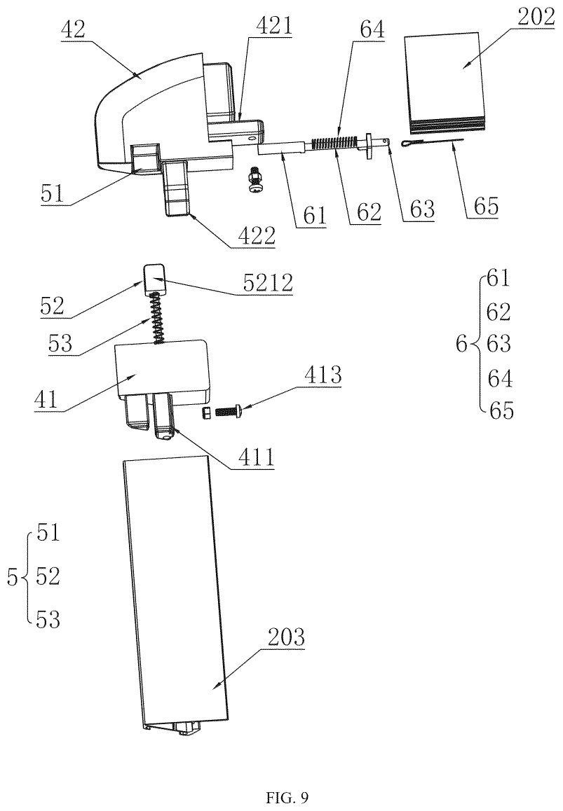

Further, referring to FIG. 8 and FIG. 9, the lock buckle 52 is sleeved with a first spring 53, and the lock buckle 52 has a lock portion 521 for inserting into the lock slot 51, the upper end of the lock portion 521 has a pressure end surface 5211, and the lower end of the lock portion 521 has a limit end surface 5212. The action relationship between the force and the lock portion 521 is: when the force is applied to the pressure end surface 5211, the lock buckle 52 retracts and disengages from the lock slot 51; when the force is applied to the limit end surface 5212, the lock buckle 52 is continuously kept in the lock slot 51 under the action of the first spring 53. On the other hand, once other forces are applied to the pressure end face 5211 during use, the elastic lock buckle 52 retracts and disengages from the lock slot 51, and the first spring 53 applies an elastic force to the lock buckle 52 to promote the lock buckle 52 to withdraw from the lock slot 51; and when other forces are applied to the limiting end face 5212, the elastic force of the first spring 53 is offset by the other forces, so the lock buckle 52 will not change and will continue to remain in the lock slot 51 to prevent it from loosening.

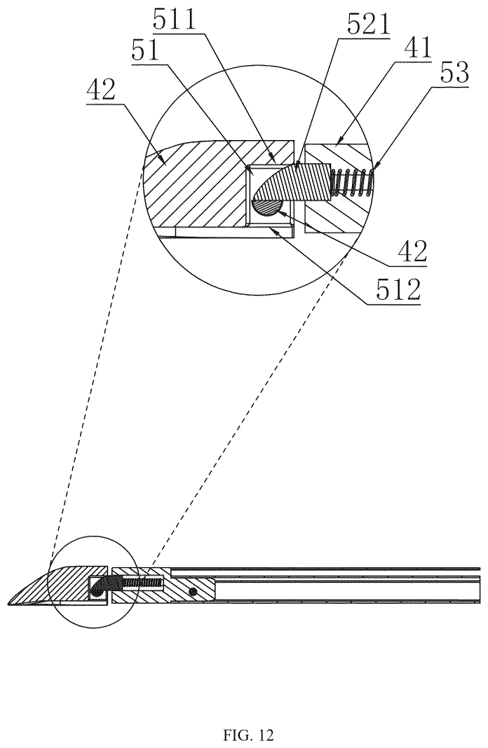

Optionally, referring to FIG. 12, the lock catch 52 and the retractable latch assembly 6 are arranged in such a manner that the lock catch 52 is arranged in the first longitudinal connection block 411 of the second linear connection member 41, and the retractable latch assembly 6 is arranged outside the first transverse connection block 421 of the rear end steering connection member 42. It should be noted that the lock catch 52 in the present utility model can be arranged on the second linear connection member 41 or on the rear end steering connection member, and correspondingly, only the position of the lock slot 51 needs to be adjusted to form an adaptation. Similarly, the retractable latch assembly 6 also needs to be accompanied by adaptive adjustment in position.

### Embodiment 4

6 to 9, based on the structural scheme of the truck covering system 101, the retractable latch assembly 6 includes a limit section 61, a main section 62 and an operating section 63. More specifically, the following description is provided:

Among them, the limiting section 61 can be extended into the lock slot 51 or withdrawn from the lock slot 51, and the limiting section 61 forms a limiting stop cooperation with the lock buckle 52 when extending into the lock slot 51; when the user releases the operating section 63, the limiting section 61 can form a limiting cooperation with the lock buckle 52 under the action of the second spring 64; when the user operates, the limiting section 61 retracts and is offset from the position of the lock buckle 52 to realize the unlocking of the retractable latch assembly 6.

The main body section 62 is sleeved with a second spring 64, which acts on the retractable latch assembly 6 so that the retractable latch assembly 6 always has a movement tendency to move toward the side of the lock slot 51, thereby achieving a self-pretightening effect and ensuring a good automatic locking effect at all times without human operation; the operating section 63 extends out of the rear end steering connector to facilitate the user to hold and operate.

In the actual use of the retractable latch assembly 6, the user's operating space may be limited by factors such as the installation position, shape and size of the operating section 63, which makes it inconvenient to directly control the retractable latch assembly 6 through the operating section 63, and the user is more likely to contact the rear end steering connection member 42 or the car frame mechanism 2 during operation and get injured. In order to solve the above defects, the solution adopted is that the truck covering system 101 includes: a pull rope 65, which is configured on the retractable latch assembly 6; the user can indirectly act on the operating section 63 through the pull rope 65 to achieve the control function of the retractable latch assembly 6. The specific working method of the pull rope 65 is: by operating the pull rope 65, the retractable latch assembly 6 is driven to move, so that the retractable latch assembly 6 is withdrawn from the lock slot 51; the pull rope 65 is released, and the retractable latch assembly 6 is re-extended into the lock slot 51 under the action of the second spring 64.

Further, the installation method of the pull rope 65 is as follows: referring to FIG. 2, the second transverse frame 202 has a slide groove 651, a movable slider 652 is provided in the slide groove 651, the pull rope 65 is connected to the slider 652, and the pull rope 65 is movably connected to the second transverse frame 202 through the slider 652. Under this structure, the pull rope 65 is a relatively slender object. If it is inconvenient for the user to pull the pull rope 65, the user can indirectly act on the pull rope 65 by moving the slider 652 to cause the pull rope 65 to move.

### Embodiment 5

13 to 19, based on the structural scheme of the truck covering system 101, this embodiment shows a preferred structural scheme of the first corner mechanism 3. The first corner mechanism 3 includes: a first linear connecting member 31, one end of which has a second longitudinal connecting block 311 and a second longitudinal slot 312, and the other end is provided with a transverse slot 313; a second corner mechanism 32, one side of which has a second transverse connecting block 321, and the other side has a second longitudinal positioning end 322 and a transverse positioning end 323.

13 to 16 and 19, the cooperation principle of the first straight connecting member 31 and the second corner mechanism 32 in this embodiment is to insert the second longitudinal positioning end 322 into the second longitudinal slot 312, and insert the transverse positioning end 323 into the transverse slot 313, so as to connect the first straight connecting member 31 with the second corner mechanism 32; then insert the second longitudinal connecting block 311 into the longitudinal frame 203, and insert the second transverse connecting block 321 into the first transverse frame 201, so as to connect the longitudinal frame 203 with the first transverse frame 201 through the first corner mechanism 3. The above arrangement can, on the one hand, play a role of pre-positioning in the assembly and connection process of the second corner mechanism 32 and the first straight connecting member 31.

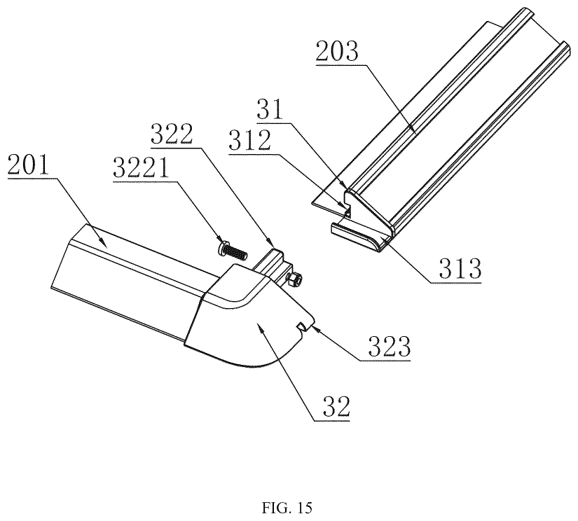

Preferably, referring to FIG. 15, both sides of the transverse slot 313 preferably have through openings 3131 so that the transverse positioning end 323 can enter and exit the transverse slot 313 along the opening to achieve convenient disassembly and assembly between the second corner mechanism 32 and the first linear connection member 31.

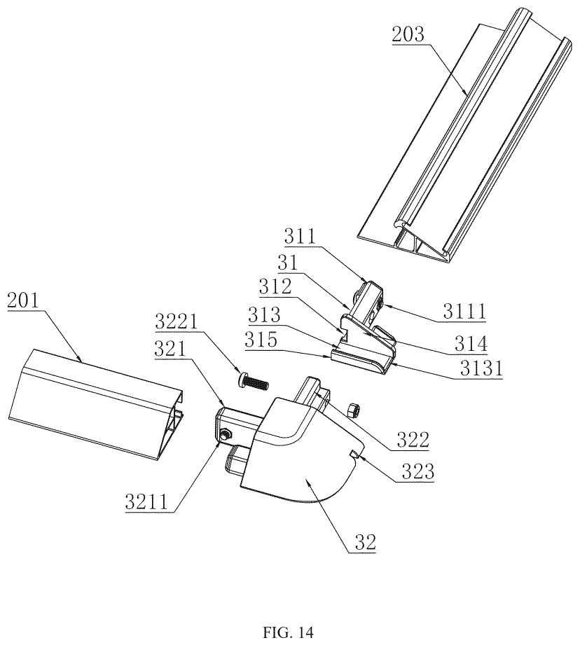

On the other hand, referring to FIG. 14, the second longitudinal connecting block 311 is fixedly connected to the longitudinal frame 203 through the third fastener 3111, the second transverse connecting block 321 is fixedly connected to the first transverse frame 201 through the fourth fastener 3211, and the second longitudinal positioning end 322 is fixedly connected to the first linear connecting member 31 through the fifth fastener 3221.

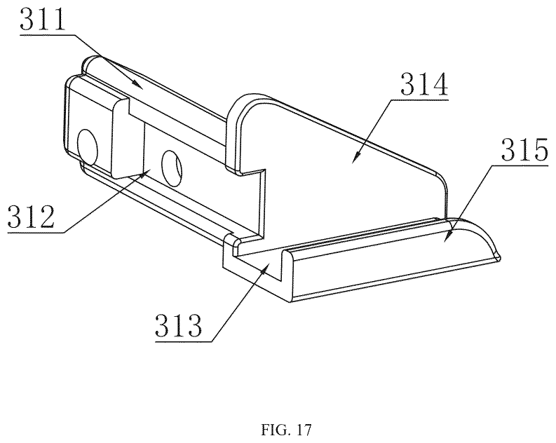

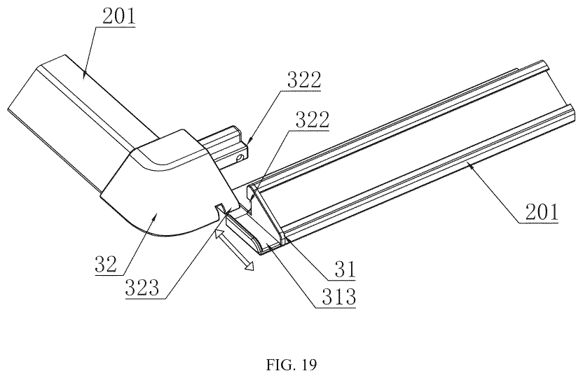

In terms of the protection structure, referring to FIG. 17 and FIG. 19, the first straight connecting member 31 has a first side wall 314, and the first side wall 314 is located between the second corner mechanism 32 and the longitudinal frame 203. The first side wall 314 is arranged on the side of the transverse slot 313 close to the longitudinal frame 203, and one side of the first side wall 314 is close to the edge of the longitudinal frame 203, and the other side is in contact with the transverse positioning end 323 in the second corner mechanism 32. The first side wall 314 fills the gap and isolates the longitudinal frame 203 from the capping mechanism 103, so as to achieve an effective protection effect.

17 and 19, a second side wall 315 is provided on the side of the transverse slot 313 away from the longitudinal frame 203, and the transverse slot 313 is formed between the second side wall 315 and the first side wall 314. The second side wall 315 is provided to cooperate with the first side wall 314 to form the transverse slot 313; secondly, it can play a similar protective effect as the first side wall 314 in the other direction of the transverse slot 313; and thirdly, it plays a structural limiting role in the process of the transverse positioning end 323 being inserted into the transverse slot 313.

Further, referring to FIG. 17, on the basis of satisfying the structural strength of the second longitudinal connecting block 311, the second longitudinal connecting block 311 is recessed inward to form the second longitudinal slot 312, so that the structure of the first corner mechanism 3 is more compact and the whole is more compact. In addition, the second longitudinal slot 312 and the transverse slot 313 are arranged perpendicular to each other. The second longitudinal slot 312 and the transverse slot 313 are matched in the transverse and longitudinal directions, so that the connection between the second corner mechanism 32 and the first linear connection member 31 is more stable and reliable.

During the unfolding or folding process of the cover mechanism 103, the second corner mechanism 32 needs to rotate and displace relative to the first straight-line connection member 31. When displacing, it is easy to shake and the stroke is incorrect when only one side is constrained. Due to the existence of the second side wall 315 and the first side wall 314, if the heights of both are high, there will be serious position interference between the second corner mechanism 32 and the first straight-line connection member 31, which will cause the second corner mechanism 32 to be unable to be smoothly unfolded or folded. In order to solve the above defects, it is necessary to impose certain restrictions on the height of each part. Preferably, the height of the first side wall 314 is greater than or equal to the height of the longitudinal frame 203, and the height of the second side wall 315 is lower than the height of the first side wall 314, so as to eliminate structural interference and ensure the smooth realization of the displacement action of the second corner mechanism 32.

### Embodiment 6

Based on the structural solution of the aforementioned truck covering system 101, this embodiment shows another preferred structural solution of the first corner mechanism 3.

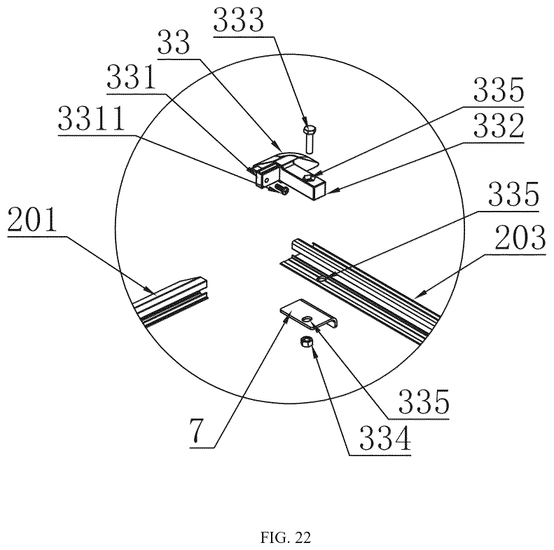

Different from the fifth embodiment, the first corner mechanism 3 in this embodiment includes, with reference to FIGS. 21 to 22:

A third corner mechanism 33, one side of which has a third transverse connecting block 331, and the other side of which has a third longitudinal connecting block 332;

Bolts 333 and nuts 334. The third longitudinal connecting block 332, the longitudinal frame 203 and the bottom plate 7 are all provided with fixing holes 335. The bolts 333 are inserted into the fixing holes 335 and then threadedly connected with the nuts 334.

The sixth fastener 3311, the third transverse connecting block 331 is fixedly connected to the first transverse frame 201 via the sixth fastener 3311.

The third corner mechanism 33 in this embodiment is used as follows: insert the third longitudinal connection block 332 into the longitudinal frame 203, and insert the third transverse connection block 331 into the first transverse frame 201, so as to make the longitudinal frame 203 and the first transverse frame 201 engage with each other through the first corner mechanism 3. Then assemble the bolt 333 and the nut 334; then the bolt 333 and the nut 334 cooperate to realize the fixed connection between the third longitudinal connection block 332, the longitudinal frame 203 and the bottom plate 7; finally, the third transverse connection block 331 is fixedly connected with the first transverse frame 201 through the sixth fastener 3311.

The above description is only a preferred embodiment of the present invention and does not limit the present invention in any way. Any simple modification, change and equivalent structural change made to the above embodiment according to the technical essence of the invention shall still fall within the protection scope of the technical solution of the present invention.

What is claimed is:

1. A truck covering system, comprising:
a car frame mechanism configured to be mounted to a side wall of a truck car having an open space;
a cover mechanism, which is mounted on the carriage frame mechanism, and the cover mechanism has at least an unfolded position and a stowed position relative to the carriage frame mechanism;
it is characterized in that the carriage frame mechanism comprises:
a first transverse frame is disposed on the front edge of the freight car body;
a second transverse frame is disposed on the rear edge of the freight car body;
a longitudinal frame is disposed on the left and right edges of the freight car body, and the longitudinal frame is located between the first transverse frame and the second transverse frame;
a first corner mechanism, wherein the front end of the longitudinal frame is fixed to the first transverse frame via the first corner mechanism;
a fourth corner mechanism, wherein the rear end of the longitudinal frame is movably connected to the second transverse frame via the fourth corner mechanism;
a corner locking mechanism is arranged in the fourth corner mechanism, and the corner locking mechanism has at least an unlocking state and a locking state relative to the fourth corner mechanism;
when the corner locking mechanism is in the unlocked state, the second transverse frame can move and separate relative to the longitudinal frame, so that the cover mechanism can switch between the unfolded position state and the stored position state;
when the corner locking mechanism is in the locked state, the fourth corner mechanism engages the second transverse frame with the longitudinal frame to restrict the cover mechanism from switching between the unfolded position state and the stored position state.

2. The truck covering system according to claim 1, characterized in that: the fourth corner mechanism comprises:
a second linear connecting member, having a first longitudinal connecting block at one end and a first longitudinal slot at the other end;
a rear end steering connection member having a first transverse connection block on one side and a first longitudinal positioning end on the other side;
the first longitudinal connection block is inserted into the longitudinal frame, the first transverse connection block is inserted into the second transverse frame, and the first longitudinal positioning end is inserted into the first longitudinal slot, so that the longitudinal frame is connected to the second transverse frame through the fourth corner mechanism.

3. The truck covering system according to claim 2, characterized in that: the corner locking mechanism comprises:
a locking groove, arranged on the rear end steering connection member;
a lock buckle is arranged on the second linear connecting member, the upper end of the lock slot is closed and the lower end is provided with an unlocking opening;
retractable latch assembly is disposed on the rear end steering connection member, and the retractable latch assembly can be extended into the lock slot or withdrawn out of the lock slot;
when the retractable latch assembly is withdrawn to the lock slot, the lock catch can be disengaged from the lock slot along the unlocking opening, so that the first longitudinal positioning end can be disengaged from the first longitudinal slot, and the corner locking mechanism is correspondingly in an unlocked state;
when the retractable latch assembly extends into the lock slot, the retractable latch assembly blocks the lower end of the lock buckle and forms a limit stop with the lock buckle, so that the lock buckle cannot escape from the lock slot, so that the first longitudinal positioning end is limited in the first longitudinal slot, and the corner locking mechanism is correspondingly in a locked state.

4. The truck covering system according to claim 2, characterized in that: the lower side and both left and right sides of the first longitudinal slot are formed with retaining edges, and the upper end of the first longitudinal slot is provided with an insertion opening;
the first longitudinal positioning end extends into or out of the first longitudinal slot through the insertion opening.

5. The truck covering system according to claim 1, characterized in that it comprises:
a bottom plate is arranged between the first corner mechanism/the fourth corner mechanism and the longitudinal frame;
the bottom plate has a horizontal portion and a vertical portion, wherein the horizontal portion is fixed to the first corner mechanism/the fourth corner mechanism via a first fastening element, and the vertical portion is fixed to the longitudinal frame via a second fastening element.

6. The truck covering system according to claim 3, characterized in that: the lock buckle is sleeved with a first spring, the lock buckle has a lock portion for inserting into a lock slot, the upper end of the lock portion has a pressure end surface, and the lower end of the lock portion has a limit end surface;
when force is applied to the pressure end surface, the lock buckle retracts and disengages from the lock groove; when force is applied to the limit end surface, the lock buckle continues to remain in the lock groove under the action of the first spring.

7. The truck covering system according to claim 3, wherein the lock is arranged in the first longitudinal connection block of the second linear connection member, and the retractable latch assembly is arranged outside the first transverse connection block of the rear end steering connection member.

8. The truck covering system according to claim 3, wherein the retractable latch assembly comprises a limit section, a main section and an operating section;
the limiting section can be extended into the lock slot or withdrawn out of the lock slot, and when the limiting section is extended into the lock slot, it forms a limiting stop with the lock buckle;
a second spring is sleeved on the main body section, and the second spring acts on the retractable latch assembly so that the retractable latch assembly always has a movement tendency to move toward one side of the lock slot;
the operating section extends out of the rear end steering connection component.

9. The truck covering system according to claim 8, characterized in that it comprises:
a pull cord, configured on the retractable latch assembly;
the retractable latch assembly is driven to move by operating the pull rope so that the retractable latch assembly is withdrawn out of the lock slot;
latch assembly will re-extend into the lock slot under the action of the second spring.

10. The truck covering system according to claim 9 is characterized in that: the second transverse frame has a slide groove, a movable slider is provided in the slide groove, the pull rope is connected to the slider, and the pull rope is movably connected to the second transverse frame through the slider.

11. The truck covering system according to claim 2, wherein the first longitudinal connecting block is connected to the longitudinal frame via a first fastener, and the first transverse connecting block is connected to the second transverse frame via a second fastener.

12. The truck covering system according to claim 1, wherein the first corner mechanism comprises:
a first linear connecting member, one end of which has a second longitudinal connecting block and a second longitudinal slot, and the other end of which is provided with a transverse slot;
a second corner mechanism, wherein one side has a second transverse connecting block, and the other side has a second longitudinal positioning end and a transverse positioning end;
insert the second longitudinal positioning end into the second longitudinal slot, and insert the transverse positioning end into the transverse slot to engage the first linear connecting member with the second corner mechanism; then insert the second longitudinal connecting block into the longitudinal frame, and insert the second transverse connecting block into the first transverse frame to engage the longitudinal frame with the first transverse frame through the first corner mechanism.

13. The truck covering system according to claim 12 is characterized in that: the second longitudinal connecting block is fixedly connected to the longitudinal frame through a third fastener, the second transverse connecting block is fixedly connected to the first transverse frame through a fourth fastener, and the second longitudinal positioning end is fixedly connected to the first linear connecting member through a fifth fastener.

14. The truck covering system according to claim 12, wherein the first linear connecting member has a first side wall, and the first side wall is located between the second corner mechanism and the longitudinal frame.

15. The truck covering system according to claim 14 is characterized in that: the first side wall is arranged on a side of the transverse slot close to the longitudinal frame, and one side surface of the first side wall is in contact with the edge of the longitudinal frame, and the other side surface is in contact with the transverse positioning end of the second corner mechanism.

16. The truck covering system according to claim 14, characterized in that a second side wall is provided on a side of the transverse slot away from the longitudinal frame, and the transverse slot is formed between the second side wall and the first side wall.

17. The truck covering system according to claim 14, wherein the second longitudinal connecting block is recessed inwardly to form the second longitudinal slot, and the second longitudinal slot and the transverse slot are arranged perpendicular to each other.

18. The truck covering system according to claim 14, wherein a height of the first side wall is greater than or equal to a height of the longitudinal frame.

19. The truck covering system according to claim 14, wherein a height of the second side wall is lower than a height of the first side wall.

20. The truck covering system according to claim 5, characterized in that: the first corner mechanism comprises:
a third corner mechanism, wherein one side has a third transverse connecting block and the other side has a third longitudinal connecting block, the third longitudinal connecting block is inserted into the longitudinal frame, and the third transverse connecting block is inserted into the first transverse frame, so that the longitudinal frame is connected to the first transverse frame through the first corner mechanism;
bolts and nuts, the third longitudinal connection block, the longitudinal frame and the bottom plate are all provided with fixed connection holes, the bolts are inserted into the fixed connection holes and then threadedly connected with the nuts;
the sixth fastener, the third transverse connecting block is fixedly connected to the first transverse frame through the sixth fastener.
